(19) United States
(12) Patent Application Publication
(10) Pub. No.: US 2025/0385980 A1
(43) Pub. Date: Dec. 18, 2025

(54) SCANNER

(71) Applicant: BROTHER KOGYO KABUSHIKI KAISHA, Nagoya (JP)

(72) Inventor: Thanh NGUYENVAN, Nagoya (JP)

(21) Appl. No.: 19/233,603

(22) Filed: Jun. 10, 2025

(30) Foreign Application Priority Data
Jun. 17, 2024 (JP) 2024-097451

(51) Int. Cl. H04N 1/00

(52) U.S. Cl. CPC H04N 1/00973; H04N 1/00222; H04N 1/00244; H04N 1/00408; H04N 1/00474; H04N 2201/0094

(57) ABSTRACT

In a case in which a predetermined scan instruction is received via a user interface, the scanner is configured to execute: a first scan process of generating first scan data indicating a first image of a document based on a result of a first scanning; and a transmission process of transmitting the first scan data to a server. In a case in which type information indicating a type of image output by a learned model based on the first scan data is received from the server via the communication interface, the scanner is configured to execute a second scan process of executing a second scanning to scan the document with a recommended parameter corresponding to the type of image based on the type information received from the server, and generating second scan data indicating a second image of the document based on a result of the second scanning.

### REFERENCE TO RELATED APPLICATIONS

This application claims priority from Japanese Patent Application No. 2024-097451 filed on Jun. 17, 2024. The entire content of the priority application is incorporated herein by reference.

### BACKGROUND ART

The technical field disclosed in the present specification relates to a scanner that reads a document image and outputs image data.

A scanner generally reads a document in accordance with a parameter corresponding to a type of a document image and outputs image data of a read image. A scanner according to an example of a technique is configured to receive a selection of a type of a document image and change a correction amount of a show-through in accordance with the type of image selected by a user.

### DESCRIPTION

In the above-described technique, the user is required to select the type of image. Therefore, this is troublesome for the user. In addition, when the user selects the type of image, the selection result is influenced by senses of the user, and thus, an appropriate type is not always selected.

A scanner includes a memory configured to store at least one recommended parameter group. The scanner is configured to scan a document. The scanner is configured to transmit first scan data to a server. The server uses a learned model that has learned so to be configured to output a type of image based on input data. The scanner is configured to scan the document with at least one recommended parameter contained in one of the at least one recommended parameter group. The one of the at least one recommended parameter group corresponds to the type of image based on the type information received from the server.

The scanner disclosed in the present specification can transmit the first scan data generated by scanning the document to the server using the learned model, and receive, from the server, the type information indicating the type of image determined by the learned model based on the first scan data. Then, the scanner can generate the second scan data by rescanning the document with the recommended parameter corresponding to the type of image based on the type information in response to receiving the selection of the rescan. Accordingly, it is possible to increase a possibility that the scan data can be obtained based on the parameter suitable for the type of the document image without the user inputting the type of image.

A control method for implementing a function of the scanner, a computer program, and a computer-readable storage medium that stores the computer program are also novel and useful.

According to the technique disclosed in the present specification, a technique that can increase a possibility of obtaining a reading result suitable for a type of a document image can be achieved.

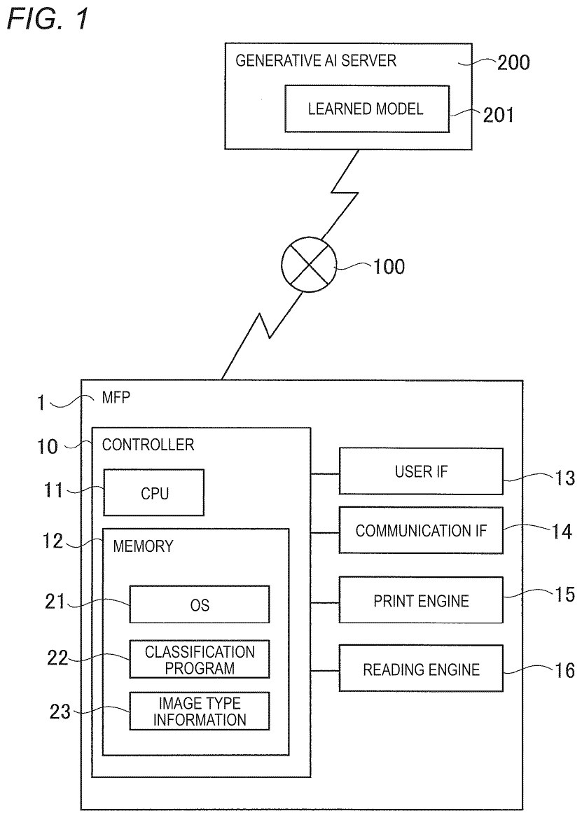

FIG. 1 is a diagram showing a schematic configuration of an MFP of the present embodiment.

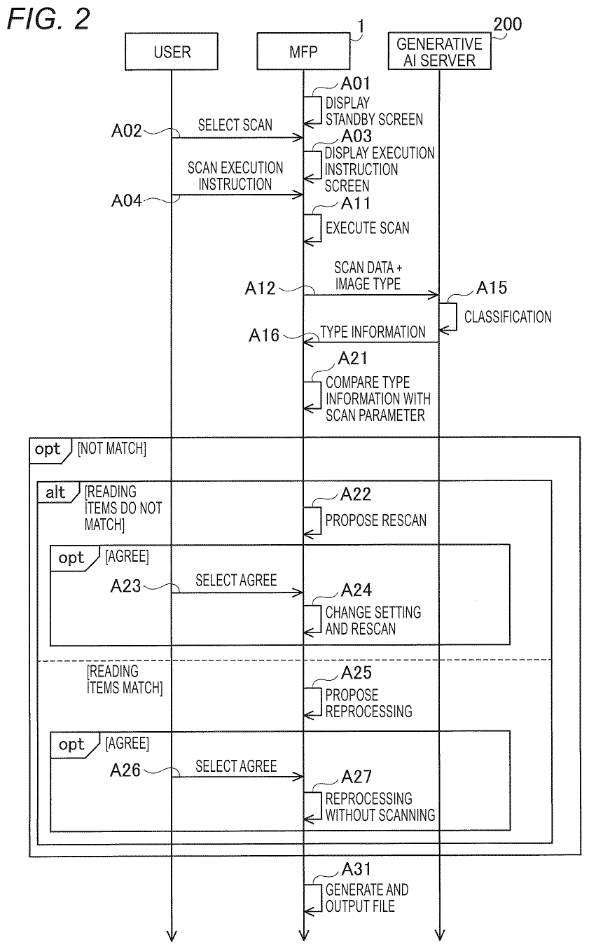

FIG. 2 is a sequence diagram showing an example of a scan procedure.

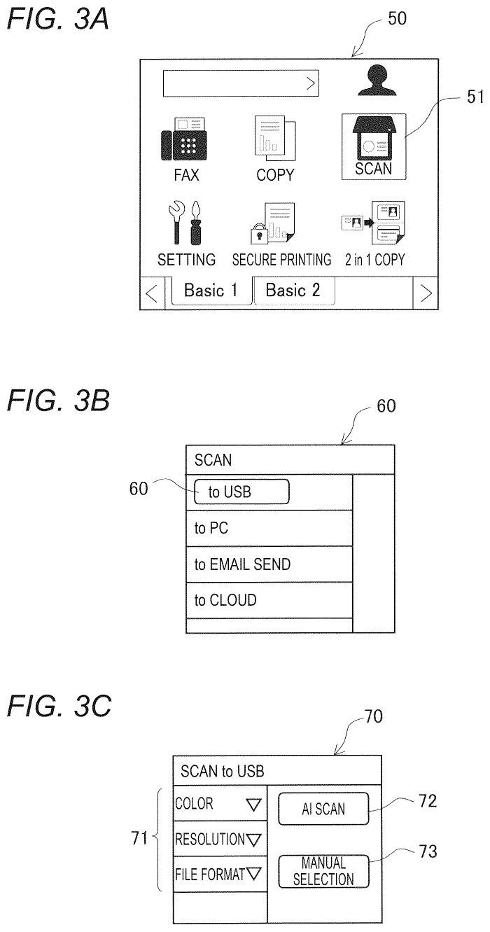

FIGS. 3A to 3C are diagrams showing an example of an operation procedure of executing a scan.

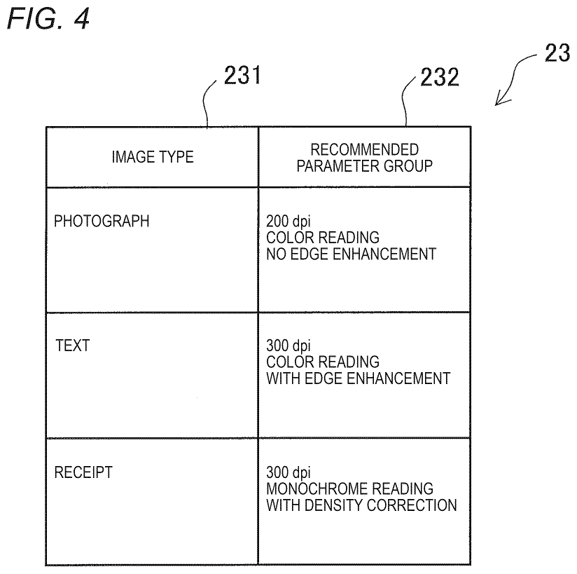

FIG. 4 is a diagram showing an example of image type information.

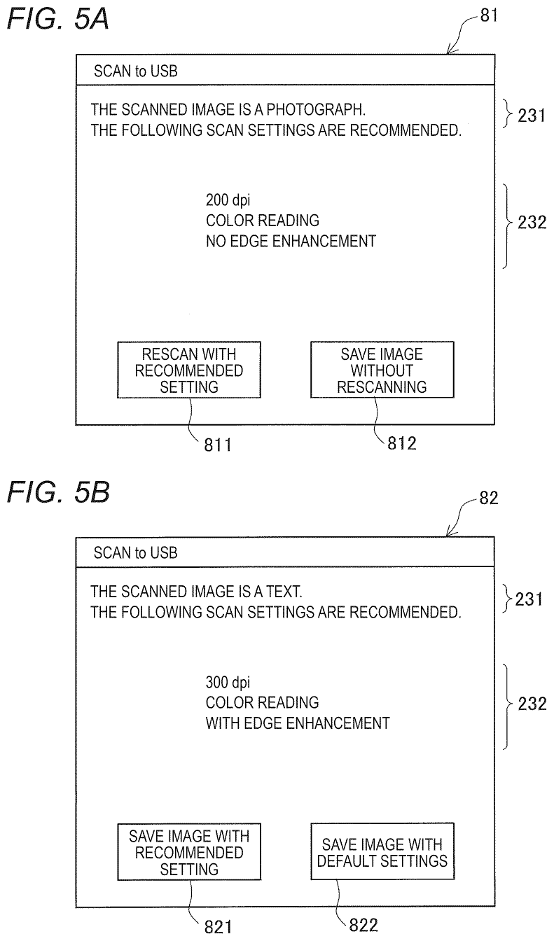

FIGS. 5A and 5B are diagrams showing examples of a selection screen.

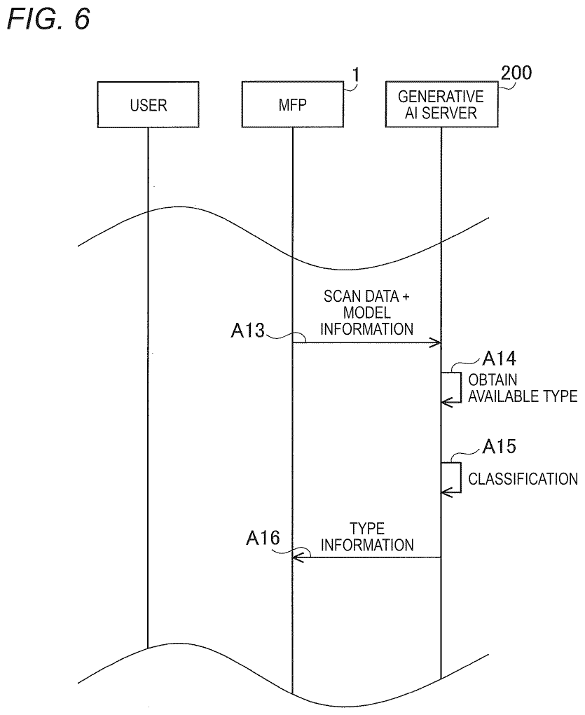

FIG. 6 is a sequence diagram showing an example of the scan procedure.

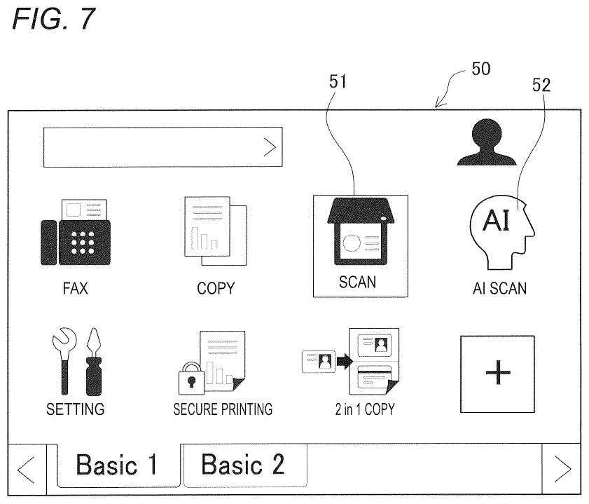

FIG. 7 is a diagram showing an example of a standby screen.

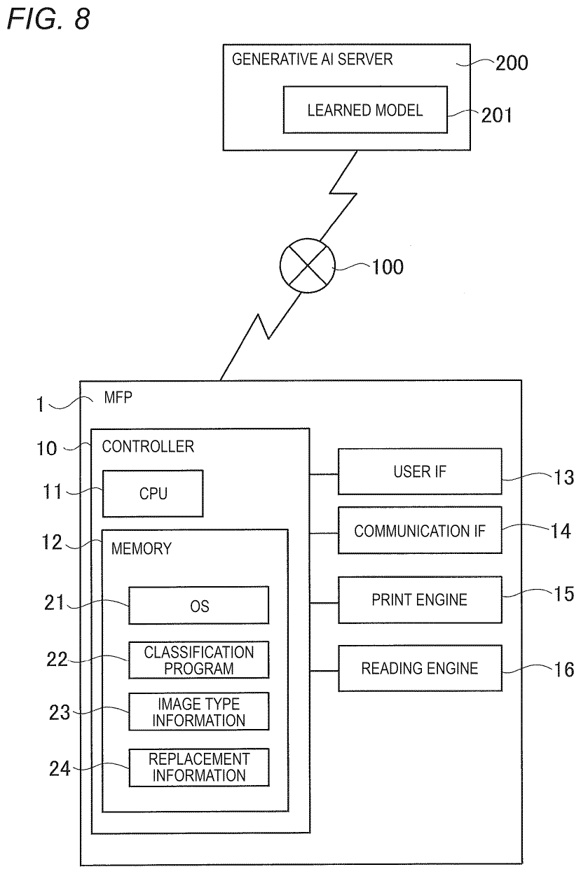

FIG. 8 is a diagram showing a schematic configuration of the MFP of the present embodiment.

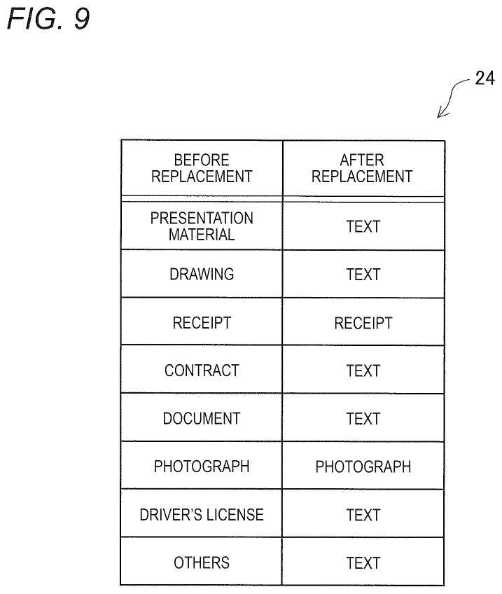

FIG. 9 is a diagram showing an example of replacement information.

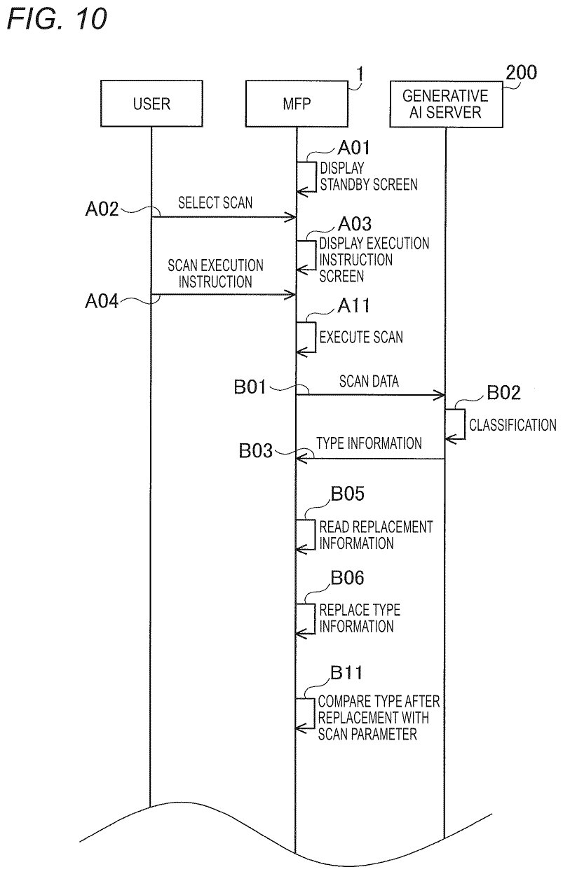

FIG. 10 is a sequence diagram showing an example of the scan procedure.

Hereinafter, a first embodiment embodying a scanner will be described in detail with reference to the accompanying drawings. The present specification discloses a multi function peripheral (hereinafter, referred to as “MFP”) having various functions including an image reading function and a communication function.

As shown in FIG. 1, an MFP 1 according to the present embodiment includes, for example, a controller 10 including a CPU 11 and a memory 12. The MFP 1 includes a user interface (hereinafter, referred to as a “user IF”) 13, a communication interface (hereinafter, referred to as a “communication IF”) 14, a print engine 15, and a reading engine 16 that are electrically connected to the controller 10. The MFP 1 is an example of a scanner. The controller 10 in FIG. 1 is a collective term for hardware and software used to control the MFP 1, and does not necessarily represent a single piece of hardware actually present in the MFP 1.

The CPU 11 of the MFP 1 executes various types of processes, in accordance with a program read from the memory 12 and based on a user operation. The memory 12 of the MFP 1 stores various types of programs including an operating system (hereinafter, referred to as an “OS”) 21 and a classification program 22, and various types of data including image type information 23. The memory 12 is used as a work area in a case where various types of processes are executed. A buffer provided in the CPU 11 is also an example of the memory 12. The program and data will be described later in detail.

An example of the memory 12 is not limited to a ROM, a RAM, an HDD, and the like incorporated into the MFP 1, and may be a storage medium configured to be read and written by the CPU 11. For example, an external memory such as a USB memory or an HDD connected to the MFP 1 via the communication IF 14, or a memory or an HDD provided in a device connected to the MFP 1 via the communication IF 14 is also an example of the memory.

The computer-readable storage medium is a non-transitory medium. The non-transitory medium also includes a recording medium such as a CD-ROM or a DVD-ROM, in addition to the above-described examples. The non-transitory medium is also a tangible medium. On the other hand, an electric signal carrying a program downloaded from a server or the like on the Internet is a computer-readable signal medium, which is a kind of computer-readable medium, but is not included in the non-transitory computer-readable storage medium.

The user IF 13 includes hardware configured to display a screen for notifying a user of information, and hardware configured to receive an operation from the user. The user IF 13 may include a touch panel having a screen display function and an operation reception function, or may include a combination of a display, hardware buttons, and the like.

The communication IF 14 includes hardware for communicating with an external device. The communication IF 14 has functions compatible with communication standards such as Wi-Fi (registered trademark), Ethernet (registered trademark), and USB. The MFP 1 may include a plurality of communication IFs 14 corresponding to a plurality of communication standards.

The print engine 15 includes a configuration for printing an image on a print medium such as a sheet. An image formation method of the print engine 15 is, for example, an electrophotographic method or an ink-jet method. The print engine 15 may be configured to perform multicolor printing or may be configured to perform only monochrome printing.

The reading engine 16 includes a configuration for scanning a document placed on a flatbed or a document placed on a document feeder and conveyed to a reading position, and generating scan data as a scan result. The MFP 1 of the present embodiment includes the reading engine 16 capable of executing both color reading for reading a document as a color image and monochrome reading for reading a document as a monochrome image.

The MFP 1 can be connected to an Internet 100 via the communication IF 14, and can access a generative AI server 200 via the Internet 100, for example, as shown in FIG. 1. The generative AI server 200 includes a learned model 201 that has learned in advance using various types of data to output answer data based on input data. The generative AI server 200 is an example of a server that uses the learned model. The learned model 201 may be a server of an AI business operator, which is published on the Internet 100. Examples of the AI business operator include OpenAI, Inc.

The learned model 201 has learned to be capable of analyzing image data and output a type of image included in the image data in response to receiving the input of the image data. For example, the learned model on the server provided by the AI business operator performs learning by using big data. Therefore, it can be expected that the image data can be analyzed and the type of image can be identified with high accuracy. For example, the learned model 201 may have information indicating a plurality of predetermined types as the type of image, and may recognize an image included in the input image data as any one of the types and give an answer. For example, the learned model 201 may answer with one of a presentation material, a drawing, a receipt, a contract, a document, a photograph, and a driver's license as the type of image. The learned model 201 may also freely perform the recognition without having a specific type of image.

The generative AI server 200 may be provided with an API for causing the learned model 201 to obtain the type of image of the input image data and returning information on the obtained type of image. For example, the MFP 1 may be able to instruct the learned model 201 to output the type of image by inputting the image data to the predetermined API provided in the generative AI server 200.

Alternatively, the generative AI server 200 may have a chat function. When a question to the chat function is received, the generative AI server 200 may be capable of outputting data generated by the learned model 201 based on the received question to a device that inputs the question. For example, the MFP 1 may be capable of inputting the image data and a character string (for example, a prompt) that instructs classification of the image data to the chat function of the generative AI server 200 to instruct the learned model 201 to classify the image.

Next, a procedure related to the scan by the MFP I will be described. The following processes basically represent processes of the CPU according to commands written in programs. That is, the processes such as “judge”, “extract”, “select”, “calculate”, “determine”, “specify”, “obtain”, “receive”, and “control” to be described below represent the processes of the CPU. The processes by the CPU also include hardware control using the API of the OS. In the present specification, the description of the OS is omitted, and an operation of each of the programs is described. That is, in the following description, the description that “a program B controls hardware C” may refer to “the program B controls the hardware C, using the API of the OS”. In addition, the processes of the CPU according to the commands written in the programs may be described in omitted words. For example, the processes of the CPU may be described as “the CPU performs”. In addition, the processes of the CPU according to the commands written in the programs may be described in words in which the CPU is omitted, such as “the program A performs”.

The term “obtain” is used as a concept indicating that a request is not essential. That is, a process of receiving data without a request from the CPU is also included in a concept indicating that “the CPU obtains data”. In addition, the term “data” in the present specification is represented by a computer-readable bit string. Furthermore, data having substantially the same meaning and different formats are treated as the same data. The same applies to “information” in the present specification. In addition, the term “request” or “instruct” is a concept indicating that information indicating that a request is being made or information indicating that an instruction is being given is output to a partner. In addition, the information indicating that a request is being made or the information indicating that an instruction is being given is simply referred to as a “request” or “instruction”.

According to the CPU, a process of determining whether information A indicates that it is a matter B may be conceptually described as “determining whether it is the matter B, based on the information A”. According to the CPU, a process of determining whether the information A indicates that it is the matter B or a matter C may be conceptually described as “determining whether it is the matter B or the matter C, based on the information A”.

A scan procedure, which is a procedure for scanning the document by using the MFP 1 and outputting scan data, will be described with reference to a sequence diagram in FIG. 2. The scan procedure is started when the MFP 1 becomes ready to receive a scan instruction.

When the MFP 1 is in a standby state, a standby screen can be displayed on the user IF 13 (A01). For example, as shown in FIG. 3A, the MFP 1 displays a standby screen 50 including a scan icon 51. In addition to the scan icon 51, a plurality of icons capable of receiving instructions for various functions executable in the MFP 1 are displayed on the standby screen 50. The MFP 1 receives an operation on each of the icons to receive a selection of a function corresponding to the operated icon. The user selects the scan function by operating the scan icon 51 in the user IF 13 (A02). The scan icon 51 is an example of a predetermined operator.

When the operation on the scan icon 51 is received, the MFP 1 displays an output destination selection screen 60 for receiving a selection of an output destination of the scan data, for example, as shown in FIG. 3B. The output destination selection screen 60 includes selection buttons such as “to USB” 61. After executing the scan to generate the scan data, the MFP 1 can output the generated scan data to the designated output destination. The output destination includes, for example, a USB memory attached to the MFP 1 corresponding to “to USB” 61, an information processing device connected to the MFP 1 corresponding to “to PC”, a mail recipient indicated by an email address registered in the MFP 1 corresponding to “to email send”, and cloud storage to which data can be uploaded from the MFP 1 corresponding to “to cloud”.

The MFP 1 may cause the standby screen to display icons indicating output destinations similar to the selection buttons in the output destination selection screen 60. When one of the icons indicating the output destinations is operated, the MFP 1 may output the scan data generated by the scan function to the output destination corresponding to the operated icon. The icons displayed on the standby screen and indicating the output destinations similar to the selection buttons in the output destination selection screen 60 may be an example of the predetermined operator.

The user can select the output to the USB memory by performing the operation on, for example, the “to USB” 61 in FIG. 3B on the output destination selection screen 60 being displayed. When the selection of the output destination of the scan data is received, the MFP 1 displays an execution instruction screen that can receive an instruction to execute the scan and a setting operation of a parameter related to the generation of the scan data (A03). The MFP 1 may be capable of receiving the instruction to execute the scan without receiving the designation of the output destination of the scan data, and may output the scan data to the predetermined output destination when the designation of the output destination is not received.

For example, as shown in FIG. 3C, the MFP 1 displays an execution instruction screen 70 including a setting field 71, an AI scan button 72, and a manual selection button 73. The setting field 71 is a field including selection buttons corresponding to various setting items related to the scan in order to receive an instruction to change parameters, which are setting values set for each of the setting items related to the scan. An operation on the setting field 71 is an example of the setting operation of the parameter related to the generation of the scan data. The AI scan button 72 is a button that receives an instruction to cause the learned model 201 (see FIG. 1) of the generative AI server 200 to recognize an image type. The manual selection button 73 is a button that receives the selection of the image type by a user operation.

The MFP 1 stores default parameters for various setting items related to the scan. When an operation on the AI scan button 72 is received without receiving an operation of changing the parameters, the MFP 1 executes a process related to the scan by using the default parameters. That is, when the operation on the AI scan button 72 is received without receiving the operation of changing the parameters, the user does not need to recognize the type of the document image by himself or herself or perform the operation of changing the parameters.

The default parameters may be values stored at the time of shipment of the MFP 1, or may be values that can be changed by an administrator or user operation after the shipment. The MFP 1 may store different values as the default parameters depending on types of the output destinations.

On the other hand, the MFP 1 can also receive the operation on the AI scan button 72 after receiving the operation of changing the parameters. When the operation on the setting field 71, specifically, the operation on one of the selection buttons included in the setting field 71 is received, the MFP 1 causes the user IF 13 to display parameter options for the setting item corresponding to the selection button. Furthermore, when the operation of selecting one of the displayed options is received, the MFP 1 changes the parameter to be used for the setting item corresponding to the operated selection button to the parameter corresponding to the selected option. The operation on the selection button and the operation on the options are examples of the setting operation of the parameter related to the generation of the scan data.

The setting items related to the scan include various setting items referred to in a case of reading by the reading engine 16 (hereinafter referred to as “reading items”) and various setting items referred to in a case of generating the scan data based on the reading result (hereinafter referred to as “output items”). Note that the output destination of the scan data is not information referred to in the case of reading or generating the scan data, and is not included in the setting items related to the scan.

The reading items include, for example, a scan resolution and a reading color. The MFP 1 can receive a selection from, for example, 200 dpi, 300 dpi, and 400 dpi as a parameter for the scan resolution based on the configuration of the reading engine 16. The MFP 1 can also receive either color reading or monochrome reading as a parameter for the reading color. The parameters of the items included in the reading items are examples of a first type parameter.

The output items include, for example, an output file format and image correction. The MFP 1 can receive a selection from, for example, JPEG, PDF, TIFF, and RAW as a parameter for the output file format. The MFP 1 can also receive parameters indicating whether to perform correction processes, such as color correction, density correction, edge enhancement correction, and background color correction, as parameters for the image correction. The parameters of the items included in the output items are examples of a second type parameter.

The MFP 1 stores recommended parameters related to the generation of the scan data for each type of a document image to be read (hereinafter, referred to as the “image type”) for various setting items related to the scan. For example, as shown in FIG. 4, the MFP 1 stores, in the memory 12, image type information 23 (see FIG. 1) in association with an image type 231 and a recommended parameter group 232. The recommended parameter group 232 is a parameter group that is recommended to be set for various setting items related to the scan when a document of the image type is scanned. The recommended parameter group 232 may be information including all parameters to be set for all setting items related to the scan, or may be information including only some parameters, for example, parameters different from the default parameters.

The MFP 1 has three types, that is, a photograph, a text, and a receipt as the image type 231, and stores the corresponding recommended parameter group 232 in association with each of the image types. Specifically, when the image type 231 is the photograph and the scan is performed with the recommended parameter group 232, the MFP 1 performs the color reading at a resolution of 200 dpi and does not perform the edge enhancement correction. When the image type 231 is the text and the scan is performed with the recommended parameter group 232, the MFP 1 performs the color reading at a resolution of 300 dpi and performs the edge enhancement correction. When the image type is the receipt and the scan is performed with the recommended parameter group 232, the MFP 1 performs the monochrome reading at the resolution of 300 dpi and performs the density correction. Note that the image type information 23 shown in FIG. 4 is an example, and the information included in the image type 231 and the recommended parameter group 232 may differ depending on a model and a firmware version of the MFP 1.

When an operation on the manual selection button 73 in the execution instruction screen 70 shown in FIG. 3C is received, the MFP 1 displays a list of the image types 231 included in the image type information 23 on the user IF 13 and receives the selection of one type. Based on the image type 231 selected by the user, the MFP 1 reads the corresponding recommended parameter group 232 and changes the parameters used when executing the scan to the read parameters. The operation on the manual selection button 73 and the operation of selecting any one of the image types 231 are examples of the setting operation of the parameter related to the generation of the scan data.

When the operation of changing the parameter is received, that is, the operation via the setting field 71 or the manual selection button 73 is received, and then the operation on the AI scan button 72 is received, the MFP 1 executes a process related to the scan by using the parameter changed based on the received operation and the default parameter of the item that does not correspond to the received operation.

The setting field 71 may be a field that displays the selected parameter for each of the setting items. In this case, when the manual selection button 73 is operated, the MFP 1 may cause the user IF 13 to display a selection button for receiving the selection of the setting item, and receive the selection of the item by the user. Then, when the operation on any one of the selection buttons is received, the MFP 1 may cause the user IF 13 to display parameter options for the setting item corresponding to the operated selection button.

Returning to the illustration of the sequence diagram in FIG. 2. The sequence diagram in FIG. 2 shows a procedure for generating the scan data by using the parameter suitable for the type of image drawn on the document by using the learned model 201 of the generative AI server 200 to output the scan data.

The user places the document on a flatbed or a document feeder, and issues a scan execution instruction by operating the AI scan button 72 on the execution instruction screen 70 (see FIG. 3C) displayed in A03 (A04). The operation on the AI scan button 72 is an example of a predetermined scan instruction.

Upon receiving the operation in A04, the MFP 1 drives the reading engine 16 to read the document image to generate the scan data (A11). A11 is an example of a first scan process, and the scan data generated in A11 is an example of first scan data.

In A11, the MFP 1 executes the scan by using the parameters set at the time of receiving the operation in A04. That is, when the user operates the AI scan button 72 without operating the setting field 71 or the manual selection button 73 on the execution instruction screen 70, the MFP 1 executes the scan with the default parameters. When the parameters are changed by operating the setting field 71 or the manual selection button 73, the MFP 1 executes the scan with the parameters reflecting the received operation.

Then, the MFP 1 transmits the generated scan data and the information indicating the list of image types 231 included in the image type information 23 to the generative AI server 200 (A12). Accordingly, the MFP 1 instructs the generative AI server 200 to classify the types of image of the scan data by the learned model 201 and to give an answer with the type information of the range included in the image type 231. The MFP 1 may perform the instruction by transmitting the scan data and the image type 231 to the generative AI server 200 via a dedicated API, or may perform the instruction by a prompt. A12 is an example of a transmission process. The scan data transmitted by the MFP 1 to the generative AI server 200 may be data as a reading result obtained by the reading engine 16, that is, RAW data, or may be data after being subjected to a process such as format conversion in the MFP 1.

The generative AI server 200 may input the scan data received from the MFP 1 to the learned model 201 after performing various processes within a range in which a content of the scan data is not greatly modified. For example, the generative AI server 200 may perform a process called a filtering process, such as a process for emphasizing features of the scan data or a process for removing noise from the scan data. In the present specification, a case where the scan data transmitted by the MFP 1 is input to the learned model 201 after undergoing various processes is also included in a category that the MFP 1 inputs the scan data to the learned model 201.

The generative AI server 200 analyzes and classifies the input scan data by using the learned model 201 (A15), and generates answer data including the type information indicating the type of image. Then, the generative AI server 200 outputs the generated answer data to the MFP 1 (A16). Accordingly, after executing the transmission in A12, the MFP 1 receives the type information indicating the type of image included in the scan data from the generative AI server 200 via the communication IF 14.

There is a possibility that the learned model 201 supports more types of image than the types included in the image type 231 of the MFP 1. That is, when the scan data is transmitted to the generative AI server 200 without the image type 231 attached, there is a possibility that the learned model 201 outputs answer data indicating a type of image not stored in the image type information 23. Since the MFP 1 transmits the scan data to the generative AI server 200 with the image type 231 attached in A12 and requests the generative AI server 200 to answer the type of image included in the image type 231, there is a high possibility that the type information output in A16 is the type of image included in the image type 231. The image type 231 transmitted by the MFP 1 to the generative AI server 200 in A12 is an example of support information.

Similar to the case of the input data, the generative AI server 200 may transmit the data output by the learned model 201 to the MFP 1 after performing various types of processes within the range in which the content of the data is not greatly modified. In the present specification, a case where the MFP 1 receives the data subjected to various processes after being output by the learned model 201 is also included in the category that the MFP 1 receives the data output by the learned model.

Based on the type information received from the generative AI server 200 in A16 and the image type information 23 stored in the memory 12, the MFP 1 compares the recommended parameter group 232 corresponding to the type information received from the generative AI server 200 with the parameters applied when the scan is executed in A11 (A21). That is, the MFP 1 determines whether the scan data obtained in A11 matches the scan data when the scan is executed with the recommended parameter group 232 corresponding to the type information. As described above, since the type information received from the generative AI server 200 is the type of image included in the image type 231 of the image type information 23, the MFP 1 can make a determination in A21 using the type information as it is.

If it is determined that the parameters do not match the recommended parameter group 232 (opt: [not match]), the MFP 1 determines whether the parameters that do not match are parameters of the reading items. For example, if the scan parameters used in A11 include the resolution of 300 dpi, the color reading, and no image correction, and the type information received from the generative AI server 200 is information indicating the photograph, the resolution, which is one of the reading items, does not match the recommended parameter group 232. On the other hand, also in a case where the scan is executed with the same parameters, if the type information received from the generative AI server 200 is information indicating the text, the reading items match the recommended parameter group 232, and the parameter of the edge enhancement process of the output items does not match the recommended parameter group 232.

If the parameters of the reading items do not match (alt: [reading items do not match]), the MFP 1 proposes a rescan and receives the selection of whether to perform the rescan (A22). A22 is an example of a selection process. For example, as shown in FIG. 5A, the MFP 1 displays a selection screen 81 including an agree button 811 for receiving a selection to agree to the rescan and a disagree button 812 for receiving a selection not to perform the rescan on the user IF 13.

For example, as shown in FIG. 5A, the MFP 1 may further display, on the selection screen 81, the image type 231 based on the type information obtained from the generative AI server 200 and the recommended parameter group 232 corresponding to the image type 231. In the case of selecting whether to perform the rescan, the image type 231 based on the type information obtained from the generative AI server 200 and the recommended parameter group 232 are displayed, so that the user can compare the image type 231 and the recommended parameter group 232 with a type of image that the user thinks of, and consider whether to perform the rescan. For example, if a type of image that is not supported by the MFP 1 is displayed on the selection screen 81, the user may be confused. The MFP 1 of the present embodiment obtains the information indicating the image type 231 available to the MFP 1 from the generative AI server 200 and displays the information, and thus the confusion of the user is avoided.

The recommended parameter group 232 displayed on the selection screen 81 may display all parameters for all items related to the scan, or may display only parameters different from the parameters used for the scan in A11. In addition, the MFP 1 may display not only the recommended parameter group 232, but also information on the parameters applied when the scan is executed in A11.

If the user agrees to the rescan, the user operates the agree button 811 on the selection screen 81 (A23). If the operation on the agree button 811 on the selection screen 81 is received (opt: [agree]), the MFP 1 drives the reading engine 16 and scans the same document with the recommended parameter group 232 (A24). For example, in the above example, if the type information is a photograph, the MFP 1 changes the resolution to 200 dpi and performs the rescan. Accordingly, the MFP 1 generates scan data corresponding to the type information obtained from the generative AI server 200. A24 is an example of a second scan process. The scan data generated in A24 is an example of second scan data.

By receiving the operation on the agree button 811, the MFP 1 automatically executes the scan with the recommended parameter group 232. That is, even when the rescan is performed, the user only needs to operate the agree button 811, and does not need to perform an operation of setting the parameter related to the generation of the scan data. Therefore, there is a high possibility that scan data based on s parameter suitable for a type of a document image can be obtained by a simple operation.

On the other hand, if the parameters that do not match are only the parameters of the output items (alt: [reading items match]), the MFP 1 proposes reprocessing and receives a selection of whether to perform the image correction (A25). For example, as shown in FIG. 5B, the MFP 1 displays, on the user IF 13, a selection screen 82 including an agree button 821 for receiving a selection to agree to the reprocessing and a disagree button 822 for receiving a selection not to perform the reprocessing. The MFP 1 may further display, on the selection screen 82, the image type 231 based on the type information obtained from the generative AI server 200 and the recommended parameter group 232 corresponding to the image type 231.

If the user agrees to the reprocessing, the user operates the agree button 821 on the selection screen 82 (A26). If an operation on the agree button 821 in the selection screen 82 is received (opt: [agree]), the MFP 1 does not drive the reading engine 16, and processes the scan result obtained in A11 in accordance with the recommended parameter group 232 (A27). For example, if the type information is the text in the above example, the edge enhancement correction is performed on the scan result obtained in A11. Accordingly, the MFP 1 can generate scan data corresponding to the type information obtained from the generative AI server 200. The scan data generated in A27 is an example of third scan data.

If the parameters that do not match are only the parameters of the output items, the MFP 1 can process the scan data generated by the scan in A11 based on the recommended parameter group 232 to generate the scan data suitable for the image type 231 without rescanning. When the operation on the agree button 821 is received on the selection screen 82, the MFP 1 does not perform the rescan, but only performs the reprocessing, and thus a need for the rescan is eliminated.

If the MFP 1 receives an operation on the disagree button 812 instead of the agree button 811 in the selection screen 81, or if the MFP 1 receives an operation on the disagree button 822 instead of the agree button 821 in the selection screen 82, the MFP 1 does not perform the rescan or reprocessing, and sets the scan data generated by the scan in A11 as the data to be output. Since the MFP 1 can receive the selection not to perform the rescan or reprocessing, and can also output the scan result of the previous scan, a user who does not care about image quality can obtain the scan data quickly. In addition, for a user who sets the parameters by operating the setting field 71 or the manual selection button 73 on the execution instruction screen 70 (see FIG. 3C) before issuing the execution instruction in A04, by selecting not to perform the rescan or reprocessing by operating the disagree button 812 or 822, the scan results based on the set parameters can be obtained.

After A24 or A27, or when the operation on the disagree button 812, 822 is received, the MFP 1 generates a file for output including the generated scan data, and outputs the file to the output destination designated on the output destination selection screen 60 (see FIG. 3B) (A31). Note that the MFP 1 may be configured to receive the selection of the output destination after generating the scan data, for example, after generating the file for output but before outputting the file, and output the file for output to the received output destination. In addition, the MFP 1 may be configured to accept the selection of the output destination after receiving the operation on the disagree button 812, 822, for example, immediately before outputting the file for output, and output the file for output to the received output destination.

If it is determined that the parameters used for the scan in A11 match the recommended parameter group 232 corresponding to the type information obtained from the generative AI server 200, the MFP 1 does not perform the rescan or reprocessing, but instead generates the file for output including the scan data generated in A11 and outputs the file to the designated output destination (A31). If there is no difference between the parameters used for the scan in A11 and the recommended parameter group 232 corresponding to the type information obtained from the generative AI server 200, the same scan result will be obtained even if the rescan is performed. Therefore, by not performing the rescan if the parameters match, the MFP 1 can output the file for output in a short time after receiving the operation on the AI scan button 72. In this case, the MFP 1 may also be configured to receive the selection of the output destination after determining that the parameters match.

A procedure in which the procedures of A12 to A27 are omitted from the procedure shown in FIG. 2, that is, a procedure in which the scan is performed in A11, and then the scan data generated by the scan is output as the file for output in A31, is a procedure for outputting the scan data without using the learned model 201. In the procedure for outputting the scan data without using the learned model 201, the MFP 1 uses the default parameters or the parameters set by the operation via the setting field 71 of the execution instruction screen 70 shown in FIG. 3C. Therefore, if a user knows in detail the type of image drawn on the document and the parameters suitable for the type of image, there is a high possibility that optimal parameters can be selected, and the scan data suitable for the type of image drawn on the document can be obtained. On the other hand, if the procedure is one shown in FIG. 2 and using the learned model 201 of the generative AI server 200, even if the user does not know in detail the type of image drawn on the document and the parameters suitable for the type of image, there is a high possibility that the scan data suitable for the type of image drawn on the document can be obtained.

As described above in detail, the MFP 1 in the first embodiment transmits the scan data generated by scanning the document to the generative AI server 200 using the learned model 201, and receives the type information from the generative AI server 200. Then, in response to receiving the selection to perform the rescan, the MFP 1 rescans the document with the recommended parameter group 232 corresponding to the image type 231 based on the type information, and regenerates the scan data. Accordingly, there is a high possibility that the scan data can be obtained based on the parameter suitable for the type of the document image without the user inputting the type of image.

The learned model 201 of the generative AI server 200 may have learned to be capable of obtaining a type of image available to each of models of the MFP 1 based on the model information. In that case, for example, as shown in FIG. 6, the MFP 1 may request to answer the type of image included in the image type 231 by transmitting the model information of the MFP 1 instead of the image type 231 in A12 in FIG. 2 (A13). Note that FIG. 6 is a modification in which the procedures of A12 to A16 in FIG. 2 are replaced, and procedures outside this range are omitted in the illustration.

In the procedure shown in FIG. 6, the learned model 201 of the generative AI server 200 obtains the information on the type of image available to the model based on the received model information (A14), and can answer a classification result of the scan data within that range. The generative AI server 200 may have information on the type of image available to each of pieces of the model information in advance, or the generative AI server 200 may obtain the above information from an external server or the like in response to the request in A13. In addition, the model information may be, for example, model information of the MFP 1, or may be a combination of the model information and the information indicating the firmware version. In this way, there is also a high possibility that the type information output from the generative AI server 200 in A16 is the type of image included in the image type 231.

In addition, the MFP 1 may display an icon that receives an instruction and is similar to the AI scan button 72 shown in FIG. 3C on the standby screen. For example, as shown in FIG. 7, the MFP 1 may display the standby screen 50 including an AI scan icon 52 on the user IF 13 in addition to the scan icon 51. When an operation on the AI scan icon 52 is received, the MFP 1 executes the scan in A11 with the default parameters and transmits the scan data to the generative AI server 200 without displaying the output destination selection screen 60 (see FIG. 3B) or the execution instruction screen 70 (see FIG. 3C).

That is, the user can start the procedure of determining the type of image by using the learned model 201 of the generative AI server 200 by operating the AI scan icon 52 without performing the setting operation of the parameter related to the generation of the scan data. The AI scan icon 52 displayed on the standby screen 50 is an example of the predetermined operator. In this way, there is also a high possibility that scan data based on parameters suitable for a type of a document image can be obtained by a simple operation.

Hereinafter, a second embodiment embodying a scanner will be described in detail with reference to the accompanying drawings. In the second embodiment, some of the procedures are different from those of the first embodiment. In the following, the same configurations and procedures as those of the first embodiment are denoted by the same reference numerals, and descriptions thereof will be omitted.

In the second embodiment, as shown in FIG. 8, in addition to the configuration of the MFP 1 in the first embodiment, the MFP 1 stores replacement information 24 in the memory 12. As shown in FIG. 9, the replacement information 24 is information indicating a relationship between the type information (before replacement) that may be received from the generative AI server 200 and the type of image (after replacement) included in the image type 231 available to the MFP 1. The replacement information 24 is an example of conversion data. The type of image available to the MFP 1 is always fewer than the type information that may be received from the generative AI server 200, and even if the information indicates the same type, a name indicating the type may be different.

Various types of information held by the generative AI server 200 may be updated. Therefore, the MFP 1 may be capable of updating the replacement information 24. For example, the MFP 1 may obtain the type information held by the generative AI server 200 and update the replacement information 24. For example, the MFP 1 may update the replacement information 24 based on an instruction of the user, or may automatically update the replacement information 24 when the MFP 1 is started or at regular intervals.

A scan procedure executed by the MFP 1 of the second embodiment will be described with reference to a sequence diagram of FIG. 10. The MFP 1 displays the standby screen 50 on the user IF 13 (A01), and the user selects a scan function (A02). The MFP 1 displays the execution instruction screen 70 (A03), and the user sets a document on the reading engine 16 and issues the scan execution instruction (A04). Accordingly, the MFP 1 reads the document image by the reading engine 16 and generates scan data (A11).

The MFP 1 of the second embodiment transmits the generated scan data to the generative AI server 200 (B01) and requests transmission of the type information indicating the type of image. B01 is an example of the transmission process. That is, unlike the MFP 1 of the first embodiment, the MFP 1 of the second embodiment transmits the scan data without attaching either the image type 231 or the model information. The generative AI server 200 classifies the scan data based on the information on the type of image stored in the generative AI server 200, and transmits the type information indicating a classification result to the MFP 1 (B03). Accordingly, the MFP 1 receives the type information.

The MFP 1, for example, reads the replacement information 24 stored in the memory 12 (B05), and replaces the received type information with the type of image included in the image type 231 available to the MFP 1 based on the replacement information 24 (B06). B06 is an example of a replacement process. By replacing the type of image with the replacement information 24 stored in the MFP 1, early replacement can be expected. Note that instead of storing the replacement information 24 in the memory 12, the MFP 1 may obtain the replacement information 24 by inquiring of an external device such as a server in response to receiving the scan execution instruction.

Furthermore, the MFP 1 compares, with the parameters when the scan is executed in A11, the recommended parameter group 232 corresponding to the type of image after replacing the answer data received from the generative AI server 200 (B11). Then, based on a comparison result, the MFP 1 receives the selection of whether to perform the rescan, similar to the first embodiment. Procedures after B11 are the same as those in the first embodiment, and thus the description is omitted.

Even if the answer data from the generative AI server 200 is information indicating the type of image not supported by the MFP 1, the MFP 1 replaces the indicated type with the image type 231 available to the MFP 1, thereby increasing the possibility that the scan data can be obtained based on the parameter suitable for the MFP 1.

As described above in detail, according to the MFP 1 of the second embodiment, there is a high possibility that the scan data can be obtained based on the parameter suitable for the type of the document image without the user inputting the type of image. Furthermore, in the MFP 1 of the second embodiment, the generative AI server 200 performs fewer processes, and there is a high possibility that an answer can be obtained in a short time. On the other hand, in the first embodiment, the MFP 1 requests the information on the type of image available to the MFP 1 from the generative AI server 200, and thus even if the type of image available to the generative AI server 200 is changed, there is a high possibility that the type information suitable for the MFP 1 can be obtained in the answer data.

The present embodiment is merely an example, and does not limit the present invention. Therefore, various improvements and modifications can be naturally made to the technique disclosed in the present specification without departing from the scope of the present invention. For example, the scanner may be a device having an image reading function and a communication function, and is not limited to the MFP 1, and may be a copy machine or a FAX device.

Further, the display form in each of the embodiments is not limited to the shown example. For example, the type, the number, the shape, and the like of the icons displayed on the standby screen 50 are not limited to the shown example. It is sufficient that the selection screens 81 and 82 are screens capable of receiving the selection of the user, and the image type 231 and the recommended parameter group 232 based on the type information obtained from the generative AI server 200 may or may not be displayed.

When an operation on a copy icon on the standby screen 50 (see FIG. 3A) is received, the MFP 1 may transmit the scan data to the generative AI server 200 before executing printing to request the type information. When the scan is executed based on the operation on the copy icon, the MFP 1 performs the scan with the default parameters. In the scan procedure executed in response to the copy instruction, the MFP 1 starts scanning without displaying the output destination selection screen 60 (see FIG. 3B), and executes the printing instead of outputting a file.

In the second embodiment, it is sufficient to be capable of replacing the answer data received from the generative AI server 200 with the image type 231 available to the MFP 1, and the replacement information 24 is not limited to a table as shown in FIG. 9. For example, it may be a conversion program that outputs the type of image available to the MFP 1 by inputting the type of image output from the learned model 201.

The generative AI server 200 is not limited to having the learned model 201, and may be capable of using the learned model 201 of another server. In this case, the generative AI server 200 passes the received scan data and the like to another server including the learned model 201, and transmits the answer data to the MFP 1 based on the answer by the learned model 201. That is, the generative AI server 200 is not limited to a server provided by an AI business operator such as OpenAI, and may be, for example, a dedicated server prepared by a manufacturer of the MFP 1 or the like.

In addition, in each of the embodiments, a configuration in which the learned model 201 of the generative AI server 200 is used has been exemplified, but instead of the learned model 201, the embodiments is also applicable to a program created based on coding of an engineer (programmer) in which a process such as a determination step is described.

In any flowchart or sequence diagram disclosed in the embodiments, an execution order of a plurality of processes in any plurality of steps can be freely changed or can be executed in parallel within a range in which no contradiction occurs in a process content.

The processes disclosed in each of the embodiments may be executed by hardware such as a single CPU, a plurality of CPUs, and an ASIC, or a combination thereof. In addition, the processes disclosed in the embodiment can be implemented in various modes such as a recording medium in which a program for executing the processes is recorded, or a method.

What is claimed is:

1. A scanner comprising:
a reading engine;
a user interface;
a communication interface; and
a memory,
wherein the memory is configured to store at least one recommended parameter group, each of the at least one recommended parameter group comprising at least one recommended parameter that is recommendable for at least one parameter related to generation of scan data, the at least one recommended parameter group being stored for at least one type of image, respectively,
wherein the scanner is configured to access a server via the communication interface, the server using a learned model that has learned so to be configured to output a type of image based on input data,
wherein in a case in which a predetermined scan instruction is received via the user interface, the scanner is configured to execute:
a first scan process of executing a first scanning to scan a document by using the reading engine, and generating first scan data indicating a first image of the document based on a result of the first scanning; and
a transmission process of transmitting the first scan data generated in the first scan process to the server via the communication interface,
wherein in a case in which type information indicating a type of image output by the learned model based on the first scan data is received from the server via the communication interface, the scanner is configured to execute a selection process of receiving, via the user interface, a selection of whether to perform a rescan, and
wherein in response to receiving a selection to perform the rescan, the scanner is configured to execute a second scan process of executing a second scanning to scan the document by using the reading engine with at least one recommended parameter contained in one of the at least one recommended parameter group, the one of the at least one recommended parameter group corresponding to the type of image based on the type information received from the server, and generating second scan data indicating a second image of the document based on a result of the second scanning.

2. The scanner according to claim 1,
wherein the scanner is configured to:
display, on the user interface, a standby screen comprising a predetermined operator, and receive, after the predetermined operator is operated, a setting operation to set the at least one parameter related to the generation of the scan data;
receive, via the user interface, the predetermined scan instruction without receiving the setting operation after the predetermined operator is operated; and
execute the first scan process and the transmission process in response to receiving the predetermined scan instruction without receiving the setting operation, the first scan process being executed to scan the document with at least one default parameter related to the generation of the scan data, and
wherein the scanner is configured to execute the selection process in a case in which the type information is received from the server via the communication interface, and execute the second scan process in response to receiving the selection to perform the rescan.

3. The scanner according to claim 2,
wherein the scanner is configured to execute the selection process in a case in which the type information is received from the server via the communication interface, and execute the second scan process without receiving the setting operation in response to receiving the selection to perform the rescan.

4. The scanner according to claim 3,
wherein after executing the selection process, the scanner is configured to:
execute the second scan process and output the second scan data generated in the second scan process in a case in which the selection to perform the rescan is received; and
output the first scan data generated in the first scan process without executing the second scan process in a case in which the selection not to perform performing the rescan is received.

5. The scanner according to claim 4,
wherein in a case in which after the predetermined operator is operated, the setting operation is received and then the predetermined scan instruction is received, the scanner is configured to execute the first scan process and the transmission process, the first scan process being executed to scan the document with the at least one parameter set in the setting operation,
wherein in a case in which the type information is received from the server via the communication interface, the scanner is configured to execute the selection process, and
wherein after the selection process, the scanner is configured to:
execute the second scan process and output the second scan data generated in the second scan process in a case in which the selection to perform the rescan is received; and
output the first scan data generated in the first scan process without executing the second scan process in a case in which the selection not to perform the rescan is received.

6. The scanner according to claim 1,
wherein in the selection process, the scanner is configured to display the type of image based on the type information received from the server, and receive the selection of whether to perform the rescan via the user interface.

7. The scanner according to claim 6,
wherein in the selection process, the scanner is configured to display the type of image which is based on the type information and which is one of at least one type of image available to the scanner, and receive the selection of whether to perform the rescan via the user interface.

8. The scanner according to claim 7,
wherein a number of the at least one type of image available to the scanner is smaller than a number of at least one type of image available to the learned model used by the server, and
wherein in a case in which the type information is received from the server via the communication interface after executing the transmission process, the scanner is configured to:
execute a replacement process of replacing the type of image indicated by the type information with a type of image in the at least one type of image available to the scanner;
execute the selection process after executing the replacement process;
display, in the selection process, the type of image based on the type information and replaced in the replacement process; and
scan, in response to receiving the selection to perform the rescan, the document with at least one recommended parameter contained in one of the at least one recommended parameter group corresponding to the type of image replaced in the replacement process, by using the reading engine in the second scan process.

9. The scanner according to claim 8,
wherein the memory is configured to store conversion data for replacing the at least one type of image available to the learned model with at least one corresponding type of image available to the scanner,
wherein in the replacement process executed in response to receiving the type information from the server via the communication interface after the transmission process is executed, the scanner is configured to replace the type of image indicated by the type information with a corresponding one of the at least one type of image available to the scanner by using the conversion data stored in the memory, and
wherein in the selection process executed after the replacement process is executed, the scanner is configured to display the type of image based on the type information and replaced in the replacement process by using the conversion data.

10. The scanner according to claim 7,
wherein the scanner is configured to:
after executing the transmission process, receive the type information indicating a type of image available to the scanner from the server via the communication interface;
in the selection process, display the type of image indicated by the type information received from the server and receive the selection of whether to perform the rescan via the user interface, and
wherein the scanner is configured to scan the document with at least one recommended parameter contained in one of the at least one recommended parameter group corresponding to the type of image indicated by the type information received from the server, by using the reading engine in the second scan process executed in response to receiving the selection to perform the rescan.

11. The scanner according to claim 10,
wherein in the transmission process, the scanner is configured to transmit, to the server via the communication interface, the first scan data generated in the first scan process in association with support information indicating the at least one type of image available to the scanner, to cause the learned model to output a type of image among the at least one type of image available to the scanner based on the support information, and
wherein the scanner is configured to:
receive, from the server via the communication interface, the type information indicating the type of image that is available to the scanner and is output by the learned model based on the support information; and
in the selection process, display the type of image indicated by the type information received from the server, and receive, via the user interface, the selection of whether to perform the rescan.

12. The scanner according to claim 10,
wherein the scanner is configured to transmit, to the server via the communication interface, the first scan data generated in the first scan process in association with model information indicating a model of the scanner, to cause the learned model to output a type of image among the at least one type of image available to the scanner based on the model information in the transmission process, the learned model that has learned so as to be configured to obtain a type of image available to corresponding one of at least one model of scanner, and
wherein the scanner is configured to:
receive, from the server via the communication interface, the type information indicating the type of image that is available to the scanner and is output by the learned model based on the model information; and
in the selection process, display the type of image indicated by the type information received from the server, and receive, via the user interface, the selection of whether to perform the rescan.

13. The scanner according to claim 1,
wherein the at least one parameter related to the generation of the scan data comprises a plurality of parameters, the plurality of parameters being classified into types, the types comprising a first parameter type comprising at least one first type parameter used for scanning by the reading engine and a second parameter type comprising at least one second type parameter used for image correction on the result of the first scanning, and
wherein in a case in which the type information is received from the server via the communication interface, the scanner is configured to:
receive a selection of whether to perform the image correction without performing the selection process of receiving the selection of whether to perform the rescan in a case in which the at least one parameter used in the first scan process includes one or more parameters, the one or more parameters being different from the at least one recommended parameter contained in the one of the at least one recommended parameter group corresponding to the type of image based on the type information received from the server, and all of the one or more parameters belonging to the second parameter type, and
generate, in response to receiving a selection to perform the image correction, third scan data in which the result of the first scanning in the first scan process is subjected to the image correction in accordance with at least one recommended second type parameter contained in the one of the at least one recommended parameter group corresponding to the type of image based on the type information received from the server.

14. A scanner comprising:
a reading engine;
a user interface;
a communication interface; and
a memory,
wherein the memory is configured to store at least one recommended parameter group, each of the at least one recommended parameter group comprising at least one recommended parameter that is recommendable for at least one parameter related to generation of scan data, the at least one recommended parameter group being stored for at least one type of image, respectively,
wherein the scanner is configured to access a server via the communication interface, the server using a learned model that has learned so as to be configured to output a type of image based on input data,
wherein in a case in which a predetermined scan instruction is received via the user interface, the scanner is configured to execute:
a first scan process of executing a first scanning to scan a document by using the reading engine, and generating first scan data indicating a first image of the document based on a result of the first scanning; and
a transmission process of transmitting the first scan data generated in the first scan process to the server via the communication interface, and
wherein in a case in which type information indicating a type of image output by the learned model based on the first scan data is received from the server via the communication interface, the scanner is configured to execute a second scan process of executing a second scanning to scan the document by using the reading engine with at least one recommended parameter contained in one of the at least one recommended parameter group, the one of the at least one recommended parameter group corresponding to the type of image based on the type information received from the server, and generating second scan data indicating a second image of the document based on a result of the second scanning.

15. The scanner according to claim 14,
wherein in a case in which the type information is received from the server via the communication interface, the scanner is configured to:
determine whether at least one parameter used for the first scanning in the first scan process matches the at least one recommended parameter contained in the one of the at least one recommended parameter group corresponding to the type of image based on the type information received from the server;
execute the second scan process and output the second scan data generated in the second scan process in a case in which the scanner determines that the at least one parameter used for the first scanning does not match the at least one recommended parameter; and
output the first scan data generated in the first scan process without executing the second scan process in a case in which the scanner determines that the at least one parameter used for the first scanning matches the at least one recommended parameter.

16. The scanner according to claim 14,
wherein a number of at least one type of image available to the scanner is smaller than a number of at least one type of image available to the learned model used by the server, and
wherein in a case in which the type information is received from the server via the communication interface after executing the transmission process, the scanner is configured to:
execute a replacement process of replacing the type of image indicated by the type information with a type of image in the at least one type of image available to the scanner; and
execute, after executing the replacement process, the second scan process to scan the document with at least one recommended parameter contained in one of the at least one recommended parameter group corresponding to the type of image replaced in the replacement process, by using the reading engine in the second scan process.

17. The scanner according to claim 16,
wherein the memory is configured to store conversion data for replacing the at least one type of image available to the learned model with at least one corresponding type of image available to the scanner,
wherein in the replacement process executed in response to receiving the type information from the server via the communication interface after the transmission process is executed, the scanner is configured to replace the type of image indicated by the type information with a corresponding one of the at least one type of image available to the scanner by using the conversion data stored in the memory, and
wherein in the second scan process executed after the replacement process is executed, the scanner is configured to perform the second scanning with at least one recommended parameter contained in one of the at least one recommended parameter group corresponding to the type of image based on the type information and replaced in the replacement process by using the conversion data.

18. The scanner according to claim 14,
wherein the scanner is configured to:
after executing the transmission process, receive the type information indicating a type of image available to the scanner from the server via the communication interface; and
in the second scan process, scan the document by using the reading engine with at least one recommended parameter contained in one of the at least one recommended parameter group corresponding to the type of image indicated by the type information received from the server.

19. The scanner according to claim 18,
wherein in the transmission process, the scanner is configured to transmit, to the server via the communication interface, the first scan data generated in the first scan process in association with support information indicating at least one type of image available to the scanner, to cause the learned model to output a type of image among the at least one type of image available to the scanner based on the support information, and
wherein the scanner is configured to:
receive, from the server via the communication interface, the type information indicating the type of image that is available to the scanner and is output by the learned model based on the support information; and
in the second scan process, scan the document by using the reading engine with at least one recommended parameter contained in one of the at least one recommended parameter group corresponding to the type of image indicated by the type information received from the server.

20. The scanner according to claim 18,
wherein the scanner is configured to transmit, to the server via the communication interface, the first scan data generated in the first scan process in association with model information indicating a model of the scanner, to cause the learned model to output a type of image among at least one type of image available to the scanner based on the model information in the transmission process, the learned model that has learned so as to be configured to obtain a type of image available to corresponding one of at least one model of scanner, and
wherein the scanner is configured to:
receive, from the server via the communication interface, the type information indicating the type of image that is available to the scanner and is output by the learned model based on the model information; and
in the second scan process, scan the document by using the reading engine with at least one recommended parameter contained in one of the at least one recommended parameter group corresponding to the type of image indicated by the type information received from the server.
